(19) United States
(12) Patent Application Publication
(10) Pub. No.: US 2023/0151860 A1
(43) Pub. Date: May 18, 2023

(54) CARRIER ASSEMBLY AND DRIVE ASSEMBLY FOR AN ACTUATOR ASSEMBLY FOR A VEHICLE BRAKE, AND ACTUATOR ASSEMBLY

(71) Applicant: ZF Active Safety GmbH, Koblenz (DE)

(72) Inventors: Volker Knop, Ulmen (DE); Nicholas Alford, Waldesch (DE); Werner Seibert, Kammerforst (DE); Christoph Beuerle, Koblenz (DE); Markus Mallmann, Pfalzfeld (DE)

(21) Appl. No.: 17/984,501

(22) Filed: Nov. 10, 2022

(30) Foreign Application Priority Data
Nov. 17, 2021 (DE) 102021129954.3

(51) Int. Cl. F16D 65/18

(52) U.S. Cl. CPC F16D 65/18; F16D 2125/40

(57) ABSTRACT

A carrier assembly for an actuator assembly for a vehicle brake is described. It comprises a plate-like frame part which has a receiving space for a planetary gear stage and a first fastening interface for an electric motor. A centre axis of the receiving space and a centre axis of the first fastening interface run generally parallel. In addition, a drive assembly for an actuator assembly for a vehicle brake is proposed which has such a carrier assembly. An actuator assembly with a drive assembly of this type is moreover presented.

### CROSS-REFERENCE TO RELATED APPLICATION

This application claims priority to German Priority Application No. 102021129954.3, filed Nov. 17, 2021, the disclosure of which is incorporated herein by reference in its entirety.

### TECHNICAL FIELD

The disclosure relates to a carrier assembly for an actuator assembly for a vehicle brake. The disclosure furthermore concerns a drive assembly for an actuator assembly for a vehicle brake which has a carrier assembly of the type mentioned at the beginning. The disclosure moreover relates to an actuator assembly for a vehicle brake, with such a drive assembly, wherein the drive assembly is arranged in a housing.

### BACKGROUND

Actuator assemblies, drive assemblies and support assemblies of the above described type are known from the prior art. Known support assemblies here serve to mount moved components of the drive assembly and position them inside the actuator assembly. The carrier assembly accordingly need to be designed to absorb reaction forces and reaction torques resulting from drive forces and drive torques. The carrier assembly therefore needs to have as stiff a design as possible.

Against this background, what is needed is to further improve known support assemblies and drive assemblies and actuator assemblies equipped therewith.

### SUMMARY

What is needed is a carrier assembly is provided with relatively high stiffness. Accordingly a carrier assembly of the type mentioned at the beginning is herein described which comprises a plate-like frame part which has a receiving space for a planetary gear stage and a first fastening interface for an electric motor. A centre axis of the receiving space and a centre axis of the first fastening interface here run essentially parallel. In this context, the designation of the fastening interface as “first” is solely for the purpose of simple explanation. A number of fastening interfaces is not implied. Moreover, a frame part is understood to mean a self-contained component. The frame part, for example, is not formed by a portion of another component. The use of a plate-like frame part entails that the carrier assembly as a whole is very stiff. This is due to the fact that the planetary gear stage can be received on the same frame part on which the electric motor can also be fastened. The high stiffness of the frame part here also exists at high temperatures which can occur during the operation of the carrier assembly. Because the centre axis of the receiving space and the centre axis of the first fastening interface extend in parallel, the carrier assembly moreover has a compact structure. Thus only a relatively small amount of space is taken up on a vehicle in which the carrier assembly is used.

In one exemplary arrangement, the frame part comprises a metal material. For example, the frame part is made from a metal material and is accordingly produced from a metal material.

In one exemplary arrangement, the first fastening interface comprises an anti-rotation device. The electric motor can thus be mounted on the frame part only in one predetermined rotational position. Moreover, a torque generated by the electric motor is reliably supported on the frame part during operation. A torque generated by the electric motor can thus be exploited reliably and efficiently.

The first fastening interface can also comprise a centring device. The electric motor to be connected to the frame part via the first fastening interface is thus mounted on the frame part in a centring fashion, A torque generated by the electric motor can consequently be imparted accurately to an actuator assembly equipped with the carrier assembly.

According to an exemplary arrangement, the receiving space is generally cylindrical or bell-shaped. A generally cylindrical receiving space here has a generally circular base. In this context, a cylinder centre axis coincides with the centre axis of the receiving space. In contrast to a generally cylindrical receiving space, a generally bell-shaped receiving space tapers along its centre axis. When viewed in the circumferential direction, an outer surface of the receiving space can be domed or curved. In a special case, a generally bell-shaped receiving space has a frustoconical design. When viewed in the circumferential direction, an outer surface then runs generally in a straight line. Receiving spaces of this type are well suited for receiving planetary gear stages without undesired cavities being thus formed. A compact structure of an actuator assembly equipped with the carrier assembly is thus ensured.

The frame part can also have a second fastening interface for a bearing sleeve for a spindle drive. A centre axis of the second fastening interface here generally coincides with the centre axis of the receiving space. The designation of the fastening interface as “second” is again solely for the purpose of simple explanation. A number of fastening interfaces is furthermore not implied. A spindle drive can thus be mounted on the frame part via the second fastening interface and the mounting sleeve. Reaction forces and reaction torques resulting from the operation of the spindle drive can consequently also be absorbed reliably by the frame part. The coaxial arrangement of the second fastening interface and the receiving space for the planetary gear stage result in a compact structure of an actuator assembly equipped with the carrier assembly.

In one exemplary arrangement, the second fastening interface comprises an anti-rotation device. Torques imparted to the bearing sleeve can consequently be supported simply and reliably on the frame part.

According to another exemplary arrangement, the anti-rotation device has an anti-rotation geometry which runs circumferentially around the centre axis of the second fastening interface and has a plurality of radial projections and radial depressions arranged alternately over the circumference. The radial projections and radial depressions are here provided with a constant pitch. A bearing sleeve equipped with a complementary geometry can thus be plugged simply into the anti-rotation geometry along the centre axis of the second fastening interface. The radial projections and radial depressions with a constant pitch here form a pattern with respect to the rotational position of the bearing sleeve. The latter can thus be fastened on the frame part in a large number of rotational positions predetermined by the pitch.

A bearing sleeve for a spindle drive can thus be connected to the frame part via the second fastening interface. In one exemplary arrangement, the bearing sleeve is plugged into the fastening interface along the centre axis of the latter. The already mentioned effects and advantages result.

In an alternative, the bearing sleeve has a linear guide geometry, acting along the centre axis of the second fastening interface, for a spindle nut. A spindle nut which can be shifted along the centre axis of the second fastening interface can thus be received in the bearing sleeve. It can be used to move a brake lining.

The bearing sleeve can also comprise an anti-rotation device for the spindle nut. A spindle nut received in the bearing sleeve can therefore not rotate relative to the bearing sleeve. The spindle nut is thus moved reliably and efficiently along the centre axis of the second fastening interface.

In one exemplary arrangement, a reinforcing part which axially spans the end of the receiving space at least partially is fastened to the frame part. The reinforcing part can in principle assume any desired shape. It is, however, in the form of a cross-piece or is cross-shaped. The reinforcing component further increases the stiffness of the frame part. Furthermore, the reinforcing part can also serve to mount drive elements, for example gear wheels.

In an alternative exemplary arrangement, at least one journal for a gear wheel is arranged on the frame part. At least one gear wheel can thus be mounted on the frame part. Reaction forces resulting from the operation of the gear wheel are reliably absorbed at the frame part as a result.

The frame part can also have a third fastening interface for a locking assembly for selectively immobilizing a drive shaft of the electric motor in rotation. The designation of the fastening interface as “third” is again solely for the purpose of simpler explanation. A number of fastening interfaces is furthermore not implied. The locking assembly can thus be mounted reliably on the frame part via the third fastening interface. As before, reaction forces and reaction torques resulting from the operation of the locking assembly are here absorbed by the frame part. Furthermore, a compact structure thus results.

In summary, the carrier assembly according to the disclosure is designed to receive all the components of a drive assembly for an actuator assembly.

In addition, a drive assembly of the type mentioned at the beginning which comprises a carrier assembly according to the disclosure. A planetary gear stage is here arranged in the receiving space. An electric motor is fastened to the first fastening interface. Moreover, at least one journal, on which a gear wheel of a gear train is mounted, is arranged on the frame part. A bearing sleeve for a spindle drive is fastened to a second fastening interface of the frame part, wherein a spindle drive is mounted on the carrier assembly by the bearing sleeve. The electric motor is thus coupled to the spindle drive drivingly via the at least one gear wheel of the gear train and the planetary gear stage. This drive assembly is configured as a separately mountable subassembly of an actuator assembly for a vehicle brake. All the essential drive components are here mounted on the carrier assembly. The drive assembly can thus, when producing an actuator assembly, be premounted separately from further components of the actuator assembly. Forces and torques which occur during operation are supported on the frame part either directly or via the bearing sleeve. The support is thus effected in particular not via mounting interfaces of different components. The drive assembly is thus relatively stiff.

In one exemplary arrangement, the drive assembly is designed so that it is not self-locking. This means that the spindle nut can shift back from its extended position into its retracted position by virtue of an axially acting compressive force without actuating the electric motor.

The effects and advantages already explained with respect to the carrier assembly also apply in the same way for the drive assembly, and vice versa.

An actuator assembly of the type mentioned at the beginning which comprises a drive assembly according to the disclosure. The high stiffness of the carrier assembly also applies in the actuator assembly. For this reason, the actuator assembly can be operated efficiently. This is because, by virtue of the high stiffness, the proportion of drive energy which flows undesirably in a deformation of the carrier assembly is relatively small. A large proportion of drive energy is thus available for actuating the actuator assembly. Furthermore, the responsiveness of the brake is improved by the high stiffness. A desired braking action can thus be set relatively quickly. An antilock braking system can consequently also be operated with increased accuracy and reliability.

Otherwise, the effects and advantages already explained with respect to the carrier assembly and the drive assembly also apply for the actuator assembly, and vice versa.

### BRIEF DESCRIPTION OF DRAWINGS

The disclosure is explained below with the aid of an exemplary arrangement which is shown in the attached drawings, in which:

FIG. 1 shows an actuator assembly according to the disclosure with a drive assembly according to the disclosure and a carrier assembly according to the disclosure in a perspective exploded view,

FIG. 2 shows the drive assembly from FIG. 1 in an isolated, partially cut-away view.

FIG. 3 shows the actuator assembly from FIG. 1 in a view in section in the plane Ill of FIG. 1, wherein a brake calliper is connected to the actuator assembly,

FIG. 4 shows the actuator assembly from FIG. 3 in a view along the line of section IV-IV, wherein a spindle drive of the actuator assembly is not illustrated,

FIG. 5 shows the carrier assembly of the drive assembly from FIG. 2 in a perspective exploded view,

FIG. 6 shows the drive assembly from FIG. 2 in a rear view, wherein a spindle drive is not illustrated,

FIG. 7 is a detailed view of a locking assembly of the actuator assembly from FIGS. 1 to 6, wherein the locking assembly assumes a locking state,

FIG. 8 shows a detailed view, corresponding to FIG. 7, of the locking assembly, wherein the locking assembly assumes a release state,

FIG. 9 shows a control assembly of the actuator assembly from FIG. 1 in a perspective exploded view, and

FIG. 10 shows the control assembly from FIG. 9 in a view in the direction X in FIG. 9.

### DETAILED DESCRIPTION

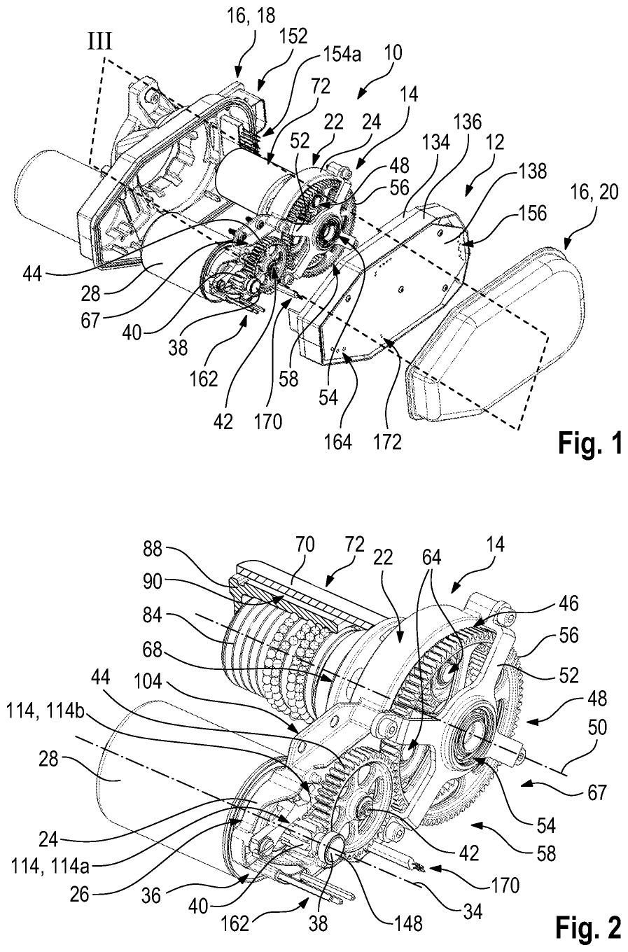

FIG. 1 shows an actuator assembly 10 for a vehicle brake.

The actuator assembly 10 comprises a control assembly 12 which can be mounted as a separate subunit and a drive assembly 14 which can be mounted as a separate subunit.

The control assembly 12 and the drive assembly 14 are arranged in a common housing 16.

The housing 16 comprises an essentially shell-shaped housing base part 18 and a housing cover 20 by which the housing base part 10 is tightly closed in the mounted state.

In the exemplary arrangement illustrated, the housing cover 20 is also generally shell-shaped.

In one exemplary arrangement, both the housing base part 18 and the housing cover 20 are produced from plastic material. The housing 16 as a whole is thus made from plastic material.

The drive assembly 14 can be seen in detail in FIGS. 2 to 6.

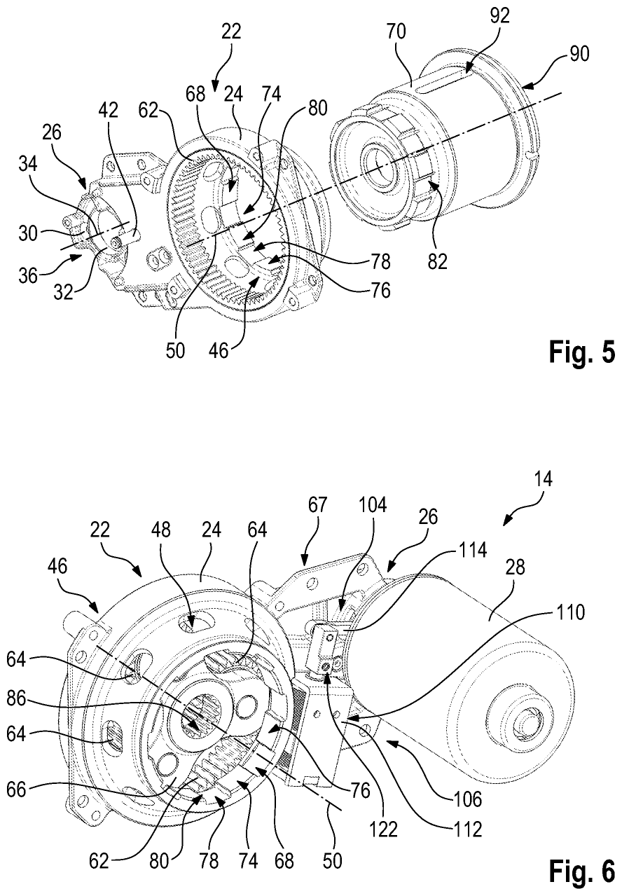

The drive assembly 14 comprises a carrier assembly 22 which has a plate-like frame part 24 (see in particular FIGS. 2 and 5).

A first fastening interface 26, at which an electric motor 28 is fastened in the exemplary arrangement illustrated, is provided at the plate-like frame part 24.

To be more precise, the electric motor 22 is connected captively to the frame part 24 via the first fastening interface 26. For this purpose, a bore 30, via which the electric motor 28 can be fastened to the frame part 24 by a fastener, such as a screw, is provided on the frame part 24 (see FIGS. 4 and 5).

Furthermore, a centring device 32 in the form of a centring surface is arranged on the frame part 24. The electric motor 28 can thus be fastened to the frame part 24 such that it is centred with respect to a centre axis 34 of the first fastening interface 26.

In addition, an anti-rotation device 36 in the form of an anti-rotation depression is provided which is designed to prevent the electric motor 28 from rotating relative to the frame part 24.

An output gear wheel 40 is arranged on an output shaft 38 of the electric motor 28 in order to impart torque to the drive assembly 14.

Furthermore, a journal 42, on which in the exemplary arrangement illustrated a gear wheel 44 is mounted which meshes with the output gear wheel 40, is provided on the frame part 24.

Moreover, a receiving space 46 for a planetary gear stage 48 is provided on the frame part 24. In the exemplary arrangement illustrated, the receiving space 46 is generally bell-shaped (see for example FIG. 5).

A centre axis 50 of the receiving space 46 is here arranged generally parallel to the centre axis 34 of the first fastening interface 26.

A reinforcing part 52 is moreover fastened to the frame part 24 in such a way that it axially spans the end of the receiving space 46 with respect to the centre axis 50.

In the exemplary arrangement illustrated, the reinforcing part is generally cross-shaped.

In addition, a bearing point 54 for a gear wheel 56 arranged coaxially with the planetary gear stage 48 is provided on the reinforcing part 52.

The gear wheel 56 meshes with the gear wheel 44.

A gear train 58 is consequently formed by the gear wheel 44 and the gear wheel 56, the output gear wheel 40 acting as its input member.

The gear wheel 56 is moreover formed integrally with a sun gear 60 of the planetary gear stage 48. In this way, the gear train 58 and the planetary gear stage 48 are coupled drivingly.

The planetary gear stage 48 moreover comprises a ring gear 62 which runs generally along an inner circumference of the receiving space 46 (see in particular FIG. 5).

In the exemplary arrangement illustrated, a total of three planetary gears 64 are provided drivingly between the sun gear 60 and the ring gear 62. They are mounted rotatably on a planet carrier 66.

The planet carrier 66 here represents an output element of the planetary gear stage 48.

The gear train 58 and the planetary gear stage 48 are also referred to together as a gear unit 67.

The frame part 24 furthermore has a second fastening interface 68 which is designed for fastening a bearing sleeve 70 for a spindle drive 72.

A centre axis of the second fastening interface 68 here coincides with the centre axis 50 of the receiving space 46 and for this reason is provided with the same reference numeral.

The second fastening interface 68 has an anti-rotation geometry 74, which is formed by a plurality of radial projections 76 and radial depressions 78 arranged alternately over the circumference, which runs circumferentially around the centre axis 50, For reasons of greater visibility, in each case only one exemplary radial projection 76 and one exemplary radial depression 78 have been provided with a reference numeral in FIGS. 5 and 6.

The radial projections 76 and the radial depressions 78 are provided with a constant pitch. This means that the radial depressions 78 each have the same length in the circumferential direction. The radial projections 76 also each have the same length in the circumferential direction. Furthermore, a radial height of the radial projections 76 is constant.

In this way, an anti-rotation device 80 of the second fastening interface 68 is formed.

A complementary geometry 82 is provided at that end of the bearing sleeve 70 which is to be coupled to the second fastening interface 68 such that the bearing sleeve 70 can be pushed along the centre axis 50 into the anti-rotation geometry 74 of the second fastening interface 68 and held there non-rotatably.

The spindle drive 72 is accommodated inside the bearing sleeve 70.

It comprises a spindle 84 which is configured in the present case as a ball screw (see in particular FIG. 2).

The spindle 84 is here connected non-rotatably to the planet carrier 66 via the toothed section 86.

The spindle drive 72 can thus be driven by the electric motor 28. In detail, the electric motor 28 is coupled to the spindle drive 72 drivingly via the gear train 58 and the planetary gear stage 48.

A spindle nut 88, which is configured as a piston, is mounted on the spindle 84. Rotation of the spindle 84 thus causes the spindle nut 88 to be shifted axially along the centre axis 50

The spindle nut 88 is here guided along the centre axis 50 on the bearing sleeve 70 by a linear guide geometry 90. The linear guide geometry 90 corresponds essentially to a cylindrical surface forming the inner circumference of the bearing sleeve 70.

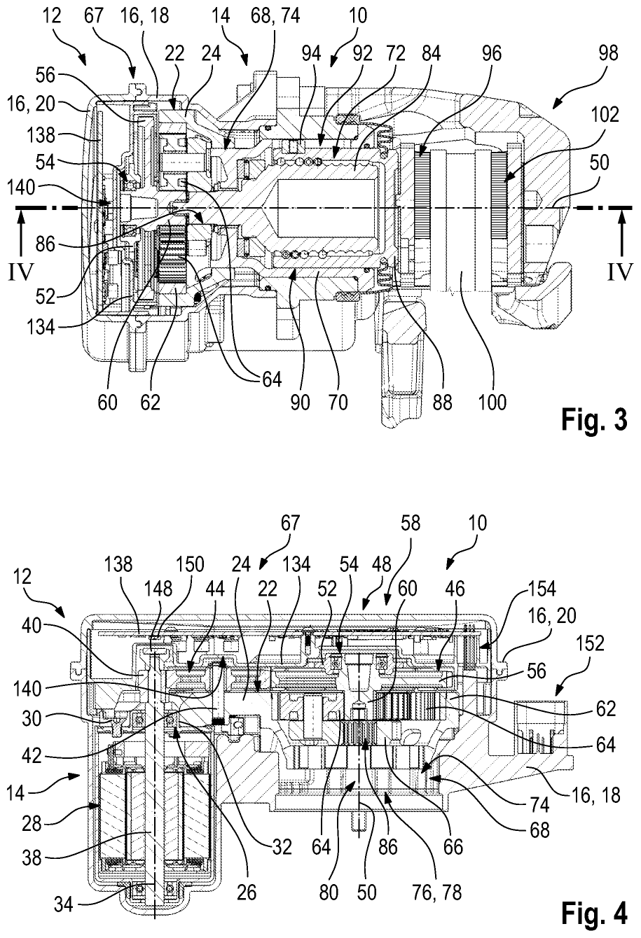

The spindle nut 88 is moreover prevented from rotating relatively about the centre axis 50 by an anti-rotation device 92 which in one exemplary arrangement, is designed as a slot on the bearing sleeve 70. For this purpose, radial extension 94 which engages in the slot (see FIG. 3) is attached to the spindle nut 88.

The spindle nut 88 furthermore serves as an actuating carriage for a first brake lining 96 of a brake calliper assembly (see FIG. 3). Since the spindle nut 88 and the actuating carriage are formed by the same component, they are provided with the same reference numeral.

The first brake lining 96 can therefore be moved actively onto a brake rotor 100, which in the exemplary arrangement illustrated is designed as a brake disc, by the actuator assembly 10.

In detail, the actuating carriage 88 is transferred selectively into an extended position, which is associated with the application of the first brake lining 96 to the brake rotor 100, by the electric motor 28 via the gear train 58, the planetary gear stage 48 and the spindle drive 72.

Because of the reaction forces acting inside the actuator assembly 10 and the brake calliper assembly 98, a second brake lining 102 is consequently also applied to the brake rotor 100 (see again FIG. 3).

It should be understood that the actuating carriage 88 can be moved in the same way by operation of the electric motor 28 into a retracted position which is associated with lifting the first brake lining 96 and the second brake lining 102 off the brake rotor 100.

In the present case, however, the actuator assembly 10 is designed so that it is not self-locking, such that the actuating carriage 88 also shifts back automatically into the retracted position by virtue of elasticities inherent in the system when it is no longer actively forced into the extended position by the electric motor 28.

A third fastening interface 104 is furthermore provided on the frame part 24 (see in particular FIG. 6).

It is designed for fastening a locking assembly 106, wherein the locking assembly 106 is in turn provided for selectively immobilizing the output shaft 38 of the electric motor 28 with respect to rotation.

In this context, the third fastening interface 104 comprises a bearing bolt 108 fastened to the frame part 24, and a fastening interface 110 for a locking actuator 112.

The locking assembly 106 is equipped with a locking lever 114 which has a first fork-shaped end 116 which receives the bearing bolt 108 for the rotational mounting of the locking lever 114.

The locking lever 114 is thus mounted on the carrier assembly 22, to be more precise on the frame part 24, so that it can rotate at its first end 116.

The locking lever 114 is coupled at the second opposite end of the latter to the locking actuator 112 via a slot 120.

In the exemplary arrangement illustrated, the locking actuator 112 is configured as a bistable solenoid.

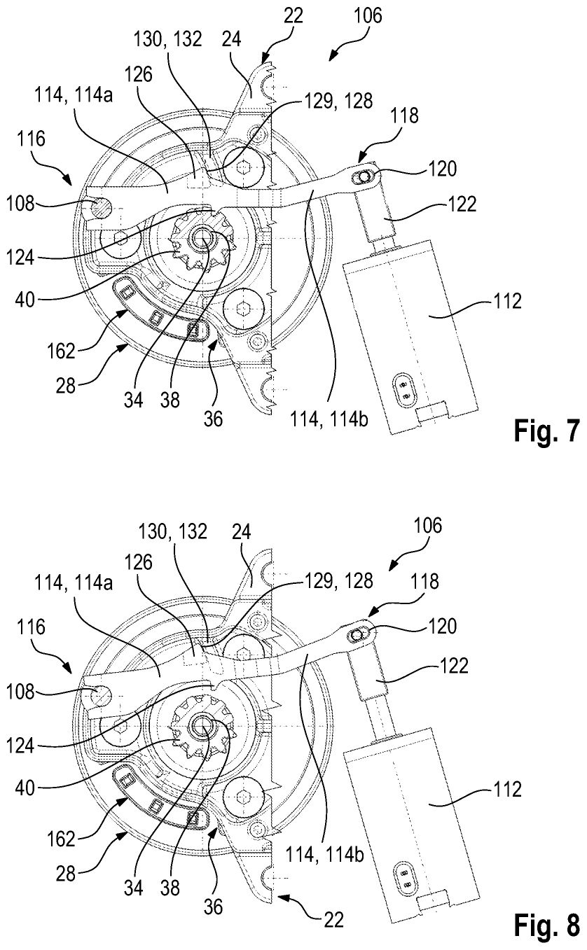

This means that an armature 122 of the locking actuator 112 can be held in both its extended position and in its retracted position without being supplied with current (see FIGS. 7 and 8). The locking actuator 112 needs to be supplied with current only in order to shift the anchor 122 between these two positions.

A ratchet 124 is moreover positioned in the longitudinal direction of the extent of the locking lever 114, between the first end 116 and the second end 118.

It is formed as a single piece with the locking lever 114.

The teeth of the output gear wheel 40 additionally acts as a locking contour.

The ratchet 124 can thus be selectively brought into engagement with the locking contour by actuating the locking actuator 112.

In the event that the ratchet 124 thus engages in the output gear wheel 40, the electric motor 28 is immobilized with respect to rotation (see FIG. 7). Such a position of the locking assembly 106 is also referred to as a locking position or locking state.

When the ratchet 124 is situated outside the teeth of the output gear wheel 40, the latter can be rotated freely. Such a position of the locking assembly 106 is referred to as the release position (see FIG. 8).

In the longitudinal direction of its extent, the locking lever 114 moreover has, between the first end 116 and the second end 118, a support projection 126, the flank 128 of which forms a support contour 129.

The support projection 126 is also integrally formed on the locking lever 114.

The flank 128 here bears, in an essentially radial direction with respect to the bearing bolt 108, against a bearing contour 132 formed as a curved wall section 130 of the frame part 24, i.e. of the carrier assembly 22.

A lateral surface, facing the flank 128, of the curved wall section 130 is here formed as a cylindrical surface section of a circular cylinder, the centre axis of which coincides with a centre axis of the bearing bolt 108.

The flank 128 is likewise formed as a cylindrical surface section of such a circular cylinder.

The locking lever 114 is therefore supported, via the support projection 126 and the bearing contour 132, with respect to such force components on the frame part 24, i.e. on the carrier assembly 22, which act essentially radially with respect to its rotational mounting about the bearing bolt 108.

Such force components result in the locking state, for example, from a torque present at the output gear wheel 40.

The bearing contour 132 can thus also be considered as a constituent part of the third fastening interface 104.

In order to be able to engage in the output gear wheel 40 for the purpose of immobilizing rotational movement of the electric motor 28, but at the same time not impede meshing of the output gear wheel 40 with the gear wheel 44, the locking lever 114 has, in the direction of its longitudinal extent, a first section 114a which comprises the first end 116. A second section 114b comprises the second end 118.

The second section 114b is here offset along the centre axis 34 with respect to the first section 114a in the direction of the electric motor 28. It is also possible to describe the locking lever 114 as having a cranked design.

It thus becomes possible for the second section 114b to run behind the gear wheel 44, viewed in the axial direction.

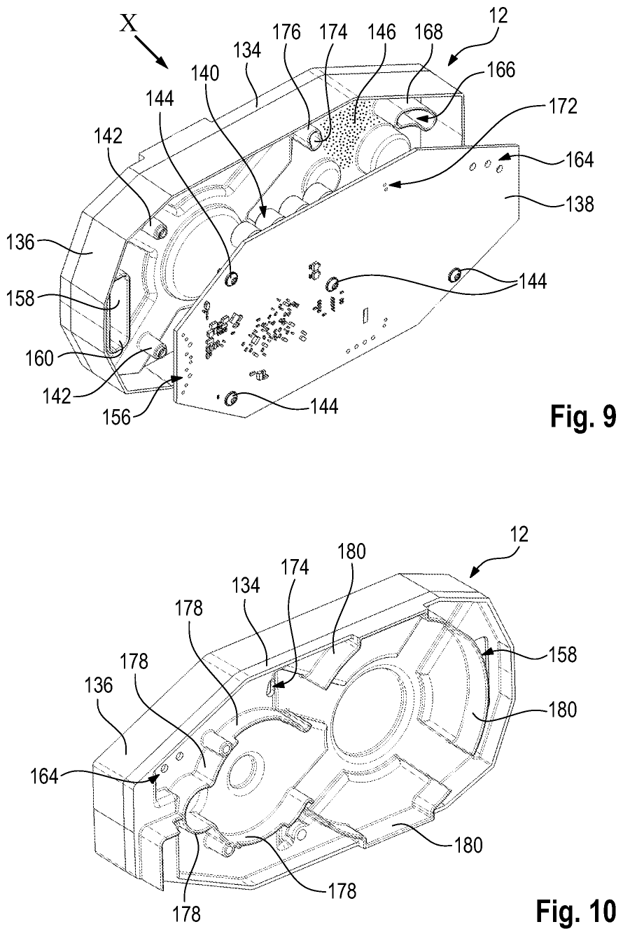

FIGS. 9 and 10 show the control assembly 12 in detail.

It comprises a bulkhead wall 134 which is provided in the embodiment illustrated with a peripheral rim 136 which runs essentially completely around the outer periphery of the bulkhead wall 134.

The bulkhead wall 134 can thus also be referred to as a bulkhead tray.

The control assembly 12 moreover comprises a printed circuit board 138 on which electrical and electronic components designated as a whole by 140 are arranged and are connected to one another electrically via traces.

The electrical and electronic components 140 here form a speed-regulating unit for regulating the speed of the electric motor 28.

A current measuring unit for measuring a current received by the electric motor 28 is moreover constructed from the electrical and electronic components 140.

The electrical and electronic components 140 furthermore represent a current supply unit for supplying electrical energy to the electric motor 28. In this connection, the electrical and electronic components 140 can also be referred to as a power electronic system.

The electrical and electronic components 140 moreover form a temperature measuring unit for measuring a temperature within the actuator assembly 10.

A force measuring unit for measuring a brake actuating force supplied by the actuator assembly is also provided by the electrical and electronic components 140.

The electrical and electronic components 140 moreover represent a control unit for the locking assembly 106.

A rotational position detection unit for identifying a rotational position of the electric motor 28 is additionally formed from the electrical and electronic components 140 and is explained in more detail below.

In order to fasten the bulkhead wall 134 and the printed circuit board 138 against each other in a predetermined relative position, means 142 for positioning and fastening the printed circuit board 138 are provided on the bulkhead wall 134.

In the exemplary arrangement illustrated in FIG. 9, the arrangement 142 for positioning and fastening are formed by fastening domes arranged on the bulkhead wall 134 and into which screws 144 are screwed which extend through the printed circuit board 138.

The bulkhead wall 134 and the printed circuit board 138 are furthermore connected to each other via a potting material 146 illustrated only schematically in an exemplary region. An intermediate space present between the bulkhead wall 134 and the printed circuit board 138 is here filled by the potting material 146. In this way, the electrical and electronic components 140 are protected from undesired external influences, in particular from vibrations and moisture. In the exemplary arrangement shown, the potting material generally completely fills the intermediate space.

The bulkhead wall 134 and the printed circuit board 138 are arranged relative to the electric motor 28 such that the output shaft 38 of the electric motor 28 is oriented perpendicular to the bulkhead wall 134 and to the printed circuit board 138.

A magnet 148 is here arranged at an end, facing the control assembly 12, of the output shaft 38 of the electric motor 28 (see in particular FIGS. 2 and 4).

An associated sensor 150 is positioned on the printed circuit board 138 at a location situated opposite the magnet 148 (see in particular FIG. 4).

The sensor 150 takes the form of a Hall effect sensor in the exemplary arrangement illustrated. In this way, a rotational position of the output shaft 38 of the electric motor 28 can be detected. Revolutions of the output shaft 38 can also be determined when evaluating the rotational position signals over time.

In order to supply the control assembly 12 and in one exemplary arrangement, the electrical and electronic components 140 with electrical energy, a plug connector half 152 is provided integrally on the housing 16, to be more precise on the housing base part 18 (see FIGS. 1 and 4).

The plug connector half 152 is here electrically connected to the printed circuit board 138 via a plurality of lines which are referred to collectively as a first electrical line 154.

Starting from the plug connector half 152, the first electrical line 154 runs initially inside the housing base part 18. In this connection, the first electrical line 154 can be integrated into the housing base part 18 when the latter is produced.

A section 154a, on the printed circuit board side, of the first electrical line 154 is here designed as dimensionally stable and protrudes from the housing base part 18 in a direction which is oriented generally parallel to the centre axes 34 and 50.

Contact openings 156 associated with the first electrical line 154 are provided on the printed circuit board 138.

A passage 158 is moreover formed on the bulkhead wall 134 such that it is ensured that the section 154a, on the printed circuit board side, reaches the printed circuit board 138 without contacting the bulkhead wall 134.

The passage 158 is additionally provided with a rim 160 such that the passage 158 is kept free of potting material 146.

When the control assembly 12 is mounted on the housing base part 18, the first electrical line 154, to be more precise its section 154a on the printed circuit board side, is consequently plugged into the associated contact openings 156. They thus form an electrical press contact.

In the exemplary arrangement illustrated, the plug connector half 152 serves not only to supply current but also to connect the actuator assembly 10 to a bus system which is, for example, a CAN bus system.

Wheel speed sensors can moreover be connected to the actuator assembly 10 via the plug connector half 152.

The electric motor 28 is also electrically connected to the printed circuit board 138.

For this purpose, dimensionally stable contacts essentially parallel to the centre axis 34 protrude from the electric motor 28 and are referred to collectively as the second electrical line 162.

Contact openings 164 on the printed circuit board 138 are likewise associated with the second electrical line 162.

A passage 166 is moreover provided on the bulkhead wall 134, through which the second electrical line 162 can come into engagement with the contact openings 164.

The passage 166 is again equipped with a rim 168 such that it is ensured that the passage 166 is kept free of potting material 146.

As already explained with regard to the first electrical line 154, when the control assembly 12 is mounted, the second electrical line 162 also enters the associated contact openings 164 and forms an electrical press contact.

The locking actuator 112 is electrically connected to the printed circuit board 138 via a third electrical line 170 (see FIGS. 1 and 2).

The third electrical line 170 is here also again formed from dimensionally stable contacts which protrude from the locking actuator 112 along the centre axes 34 and 50.

Contact openings 172 in the printed circuit board 138 are again associated with the third electrical line 170 (see FIG. 9).

So that the third electrical line 170 can be plugged into the contact openings 172, a passage 174 is additionally provided on the bulkhead wall 134. It is equipped with a rim 176 such that the passage 174 is also kept free of potting material 146.

As already explained with regard to the first electrical line 154 and the second electrical line 162, the third electrical line 170 is also pushed into the associated contact openings 172 and forms an electrical press contact when the control assembly 12 is mounted.

In summary, the printed circuit board 138 is therefore coupled electrically both to the plug connector half 152 and to the electric motor 28 and the locking actuator 112.

On a side, facing the drive assembly 14, of the bulkhead wall 134, retaining ribs 178 are additionally provided in the region of the output gear wheel 40 and the gear wheel 44 which essentially form an envelope around a gear stage formed by the output gear wheel 40 and the gear wheel 44.

Retaining ribs 180 are also provided in the region of the planetary gear stage 48.

The retaining ribs 178, 180 here serve to ensure that a lubricating medium is held in the region of the gear wheels to be lubricated even when the output gear wheel 40, the gear wheel 44 and the planetary gear wheel 48 rotate.

A function of a service brake can be provided by the actuator assembly 10 if the actuator assembly 10 is coupled to the brake calliper assembly 98. The actuator assembly 10 is then operated in a service brake mode. The electric motor 28 is thus controlled by the control assembly 12 in such a way that it effects a desired shifting of the spindle nut 88, i.e. of the actuating carriage 88, along the centre axis 50 via the gear train 58, the planetary gear stage 48 and the spindle drive 72.

The electric motor 28 can here, in principle, be actuated in both directions of rotation such that the actuating carriage 88 can also be shifted actively in both directions.

It is likewise conceivable to use the electric motor 28 only to displace the actuating carriage 88 into an extended position, i.e. to apply the brake lining 96 to the brake rotor 100.

The actuating carriage 88 can be restored to a retracted position and the pressure on the brake lining 96 can therefore be relaxed in this connection by virtue of elasticities which are inherent in the system, on the one hand, and the design of the actuator assembly 10 as not self-locking, on the other hand.

In such a service brake mode, the locking assembly 106 at all times assumes the release state (see FIG. 8).

A function of a parking brake can moreover be provided by the actuator assembly 10.

In this connection, a parking brake mode can be activated by the spindle nut 88 which forms the actuating carriage 88 being transferred into its extended position the electric motor 28 and the brake lining 96 thus being applied to the brake rotor 100. The brake lining 102 is thus also applied to the brake rotor 100 by virtue of reaction forces acting inside the actuator assembly 10.

The locking assembly 106 is then transferred into the locking state by the locking actuator 112 (see FIG. 7).

Up to the point at which the ratchet 124 actually engages in the teeth of the output gear wheel 40 and rotation of the output shaft 38 is thus immobilized, the spindle nut 88 which forms the actuating carriage 88 is held actively in the extended position by the electric motor 28, i.e. the electric motor 28 is correspondingly supplied with current.

The delivery of current to the electric motor 28 is interrupted only if the ratchet 124 engages securely in the locking contour formed by the teeth of the output gear wheel 40.

There are several alternatives for deactivating the parking brake mode.

In one exemplary arrangement, to do this the electric motor 28 is actuated in a direction in which it stresses the spindle nut 88 which forms the actuating carriage 88 into the extended position, i.e. shifts it in the direction of the brake lining 96.

In this way, the force on the locking lever 114 is relaxed.

The locking lever 114 can thus be easily transferred from the locking position into the release position by the locking actuator 112 (see FIGS. 7 and 8).

Supply of current to the electric motor 28 can then be stopped such that the spindle nut 88 moves back automatically into the retracted position by virtue of the lack of any self-locking effect.

It is alternatively conceivable that the locking lever 114 is transferred into the release position not by actuation of the locking actuator 112 but by the electric motor 28 being actuated in a direction corresponding to the extended position of the spindle nut 88 in such a way that the locking lever 114 is forced into its release position by the electric motor 28.

The electric motor 28 can then be operated in a direction associated with the retracted position of the spindle nut 88 such that the parking brake mode is deactivated.

It is of course also conceivable to deactivate the parking brake mode only by actuating the locking lever 114 by the locking actuator 112. In this alternative, the electric motor 28 is not used to deactivate the parking brake mode. It may therefore not be necessary to shift the locking lever 114 under load.

The actuator assembly 10 can be produced as follows.

First, the housing base part 18 is supplied.

Then, the already premounted drive assembly 14 is inserted into the housing base part 18.

As already explained, the drive assembly 14 comprises the carrier assembly 22 on which are mounted the electric motor 28, the spindle drive 72 and the gear unit 67 coupling the electric motor 28 and the spindle drive 72 drivingly and which comprises the gear train 58 and the planetary gear stage 48.

The control assembly 12 is then inserted into the housing base part 18.

As already explained, the control assembly 12 comprises the bulkhead wall 134 and the printed circuit board 138.

The electric motor 28 is additionally connected electrically to the printed circuit board via the second electrical line 162 by the insertion of the control assembly 12 into the housing base part 18.

The plug connector half 152 is moreover connected electrically the printed circuit board 138 via the first electrical line 154.

The locking actuator 112 is also connected to the printed circuit board 138 via the third electrical line 170 when the control assembly 12 is inserted.

The electrical connections are here in each case created by the electrical lines 154, 162, 170 being plugged into the respective associated contact openings 156, 164, 172 to form a press contact.

Lastly, the housing base part 18 is closed by the housing cover 20 being placed on top.

1. A carrier assembly for an actuator assembly for a vehicle brake, comprising a frame part which has a receiving space for a planetary gear stage and a first fastening interface for an electric motor, wherein a centre axis of the receiving space and a centre axis of the first fastening interface run generally parallel.

2. The carrier assembly according to claim 1, wherein the first fastening interface comprises an anti-rotation device.

3. The carrier assembly according to claim 1, wherein the first fastening interface comprises a centring device.

4. The carrier assembly according to claim 1, wherein the receiving space is cylindrical or bell-shaped.

5. The carrier assembly according to claim 1, wherein the frame part has a second fastening interface for a bearing sleeve for a spindle drive, wherein a centre axis of the second fastening interface coincides with the centre axis of the receiving space.

6. The carrier assembly according to claim 5, wherein the second fastening interface comprises an anti-rotation device.

7. The carrier assembly according to claim 6, wherein the anti-rotation device has an anti-rotation geometry which runs circumferentially around the centre axis of the second fastening interface and has a plurality of radial projections and radial depressions arranged alternately over a circumference, wherein the radial projections and the radial depressions are provided with a constant pitch.

8. The carrier assembly (22) according to claim 6, wherein a bearing sleeve for a spindle drive, which is connected to the frame part via the second fastening interface.

9. The carrier assembly according to claim 8, wherein the bearing sleeve has a linear guide geometry, acting along the centre axis of the second fastening interface, for a spindle nut.

10. The carrier assembly according to claim 8, wherein the bearing sleeve comprises an anti-rotation device for a spindle nut.

11. The carrier assembly according to claim 1, wherein a reinforcing part which axially spans the end of the receiving space at least partially is fastened to the frame part.

12. The carrier assembly according to claim 1, wherein at least one journal for a gear wheel is arranged on the frame part.

13. The carrier assembly according to claim 1, wherein the frame part has a third fastening interface for a locking assembly for selectively immobilizing a drive shaft of the electric motor in rotation.

14. A drive assembly for an actuator assembly for a vehicle brake, with a carrier assembly according to claim 1, wherein
an electric motor is fastened to the first fastening interface,
at least one journal, on which a gear wheel of a gear train is mounted, is arranged on the frame part,
a bearing sleeve for a spindle drive is fastened to a second fastening interface of the frame part, wherein a spindle drive is mounted on the carrier assembly by the bearing sleeve,
wherein the electric motor is coupled drivingly to the spindle drive via the at least one gear wheel of the gear train and the planetary gear stage.

15. An actuator assembly for a vehicle brake, with a drive assembly according to claim 14, wherein the drive assembly is arranged in a housing.

16. The carrier assembly according to claim 7, wherein a bearing sleeve for a spindle drive, which is connected to the frame part via the second fastening interface.

17. The carrier assembly according to claim 16, wherein the bearing sleeve has a linear guide geometry, acting along the centre axis of the second fastening interface, for a spindle nut.

18. The carrier assembly according to claim 9, wherein the bearing sleeve comprises an anti-rotation device for a spindle nut.

19. The carrier assembly according to claim 18, wherein a reinforcing part which axially spans the end of the receiving space at least partially is fastened to the frame part.
